(19) United States
(12) Patent Application Publication
(10) Pub. No.: US 2009/0255759 A1
(43) Pub. Date: Oct. 15, 2009

(54) Ladder stabilizing and standoff system

(76) Inventor: Gregory K. Barnes, Fort Worth, TX (US)

Correspondence Address: JACKSON WALKER, L.L.P., 112 E. PECAN, SUITE 2400, SAN ANTONIO, TX, 78205, US

(21) Appl. No.: 12/082,544

(22) Filed: Apr. 10, 2008

(51) Int. Cl. E06C 7/48

(52) U.S. Cl. 182/204

(57) ABSTRACT

A ladder stabilizing system and standoff device comprising a base having a leg receiving portion typically a straight member. The base also includes a U-shaped member. The leg receiving member has removed ends that may telescopically receive a number of different shaped removable legs. The removable legs are in various configurations for use with walls of various configurations. The U-shaped member will attach by clamps to the ladder and the leg receiving member of the base, with the legs thereon, will rest against the wall, when the system is in use.

### FIELD OF THE INVENTION

Ladder stabilizing and standoff devices.

### BACKGROUND OF THE INVENTION

Various ladder stabilizing and standoff devices have been provided in the prior art. The purpose of a ladder stabilizing device is to provide stability when leaning against a building so that various tasks may be accomplished safely. The purpose of a ladder standoff is to prop the top of a ladder away from the vertical surface against which it is leaning. Therefore, the prior art has recognized a need in providing structure between the ladder and a building, which will help stabilize and/or standoff the ladder with respect to the building.

Prior art ladder stabilizing devices have been more or less effective in providing stability and standoff devices have been more or less effective in keeping the ladder apart from the buildings, but they suffer from defects that make them less than optimal.

Applicant has found, in part through experimentation, the effectiveness of the novel system set forth herein to address at least some of the shortcomings of the prior art. Applicant believes his system will set a new standard for safety and simplicity, offering one system to address many different scenarios.

### SUMMARY OF THE INVENTION

Applicant's ladder stabilizing and standoff system includes a base. The base is comprised of a straight leg receiving member having a pair of removed ends and a U-shaped member attached to the straight leg receiving member through lateral members. (See FIG. 1)

A multiplicity of base engaging leg member pairs are provided. Each leg member of a pair has a straight near end that will telescopically engage the removed ends of the leg receiving member. The base includes a U-shaped member for receiving a ladder thereon, the U-shaped member spaced apart from the straight leg receiving member. The U-shaped member is fastened tight and flush against the rails of the ladder with brackets, clamps, nuts, bolts or other means of fastening.

At least one leg member pair is straight and at least one leg member pair has curved removed ends. Each of the near ends of each leg member of each leg member pair is straight so as to telescopically or otherwise engage the straight removed ends of the straight leg receiving member of the base.

A multiplicity of fastener holes are provided in one or both the removed ends of the straight leg receiving member and the near ends of the leg member pairs, which fastener holes can be aligned, and when a fastener is slipped through the aligned holes, will adjustably set the leg members with the base, the adjustment being the distance between the removed ends of the leg members.

By adjustably setting the distance of the removed ends of the leg member pairs that have a radius angle greater than 90 degrees, one can adjustably set the system against the curvature of a wall to give excellent stability, seeing as how the straight leg receiving member and the removed ends of the curved leg member pairs should contact the surface. (See FIG. 5)

By using the straight leg member pairs, one may increase the stability of a ladder against a flat wall even more, because the entire length of the straight leg receiving member and the removed ends of the straight leg member pairs should contact the surface. (See FIG. 2) Also, when the need arises to bridge an opening, such as on a curtain wall, the straight leg member pairs may be telescopically adjusted to accommodate the size of the opening, so that the removed ends will contact the surface they are intended to contact, such as the metal and not the glass, up to typically, but not necessarily, eight feet wide. (See FIGS. 9, 10)

By using the leg member pairs that have a 90 degree angle, which are also telescopically adjustable, the system offers flexibility in that it can bridge windows or other obstructions, up to typically, but not necessarily, eight feet wide. (See FIG. 4)

By using the leg member pairs that have an approximate 45 degree angle, one may have access to the corner of buildings. (See FIG. 3)

The system may also be used without any leg member pairs in place, which means that the straight leg receiving member would rest against the building, offering excellent stability and standoff. This is suitable for flat walls.

The ladder stabilizing and standoff system may include engagement structure for telescoping engagement of paired leg members to removed ends of straight leg receiving member.

In one preferred embodiment, the paired leg members are received within the straight leg receiving member, and in another embodiment, the straight leg receiving member is adapted to slide within the larger diameter of the near ends of the paired leg members. Both embodiments are designated telescoping engagement.

In another alternate preferred embodiment of Applicant's system, adjustable feet are provided at the removed ends of the paired leg members, usually the ones that have an approximate forty five degree angle, and the removed ends of the paired leg members that have an approximate ninety degree angle. The feet typically being provided to adjust or pivot along an axis parallel to an axis defined by the plane of the base. Among other advantages, the adjustable feet may provide a more secure engagement to the wall.

In an alternate preferred embodiment, Applicant may provide for an adjustable distance between the U-shaped member of the base and the leg receiving member of the base, by providing for adjustable lateral members. (See FIGS. 2, 5)

In an alternate preferred embodiment, Applicant may provide sets of paired leg members with differing lengths. For example, paired leg members 42a, 42b may come in lengths of one foot six inches or two foot six inches, or any other lengths.

### BRIEF DESCRIPTION OF THE DRAWINGS

FIG. 1 is a perspective view of Applicant's novel ladder stabilizing and standoff system 10 illustrating the manner in which paired leg members are interchangeable with one another to adapt the system to a variety of configurations for a variety of ladder stabilizing and standoff scenarios.

FIG. 2 is a top elevation view of Applicant's novel system in one configuration, with straight paired leg members against a flat wall.

FIG. 3 illustrates yet another configuration of Applicant's novel system illustrating the use of corner paired leg members for stabilizing a ladder adjacent a corner of a building or other structure.

FIG. 4 provides a perspective view of another embodiment of Applicant's novel ladder stabilizing and standoff system used to straddle a wall that may have an obstruction or other structure that would interfere with the use, for example, of the straight paired leg members. FIG. 4 illustrates the use of standoff paired leg members.

FIG. 5 illustrates yet another configuration of Applicant's novel system illustrating curved paired leg members against the curvature of a wall.

FIG. 6 illustrates one of the preferred embodiment's mentioned in paragraph (15) showing the straight leg receiving member adapted to slide within the larger diameter of the near ends of the paired leg members.

FIG. 7 illustrates the preferred embodiment mentioned in paragraph (16) showing one version of adjustable feet that may be provided at the removed ends of the paired legs.

FIG. 8 illustrates the preferred embodiment mentioned in paragraph (17) showing that at least two sets of paired leg members 24a/24b, 30a/30b, 36a/36b, and 42a/42b may be provided, wherein they differ from one another in the length of straight near ends.

FIG. 9 illustrates another configuration of Applicant's novel system illustrating straight paired leg members telescoped so that removed ends rest on metal and not glass.

FIG. 10 illustrates yet another configuration of Applicant's novel system illustrating the use of straight paired leg members against a curtain wall of glass and metal.

### DETAILED DESCRIPTION OF PREFERRED EMBODIMENT

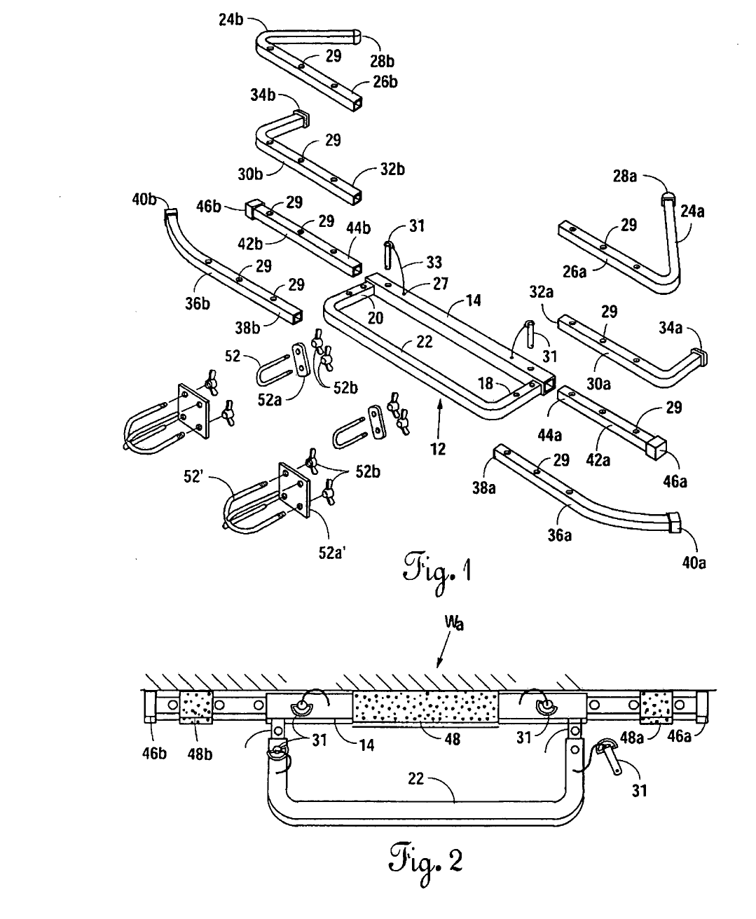

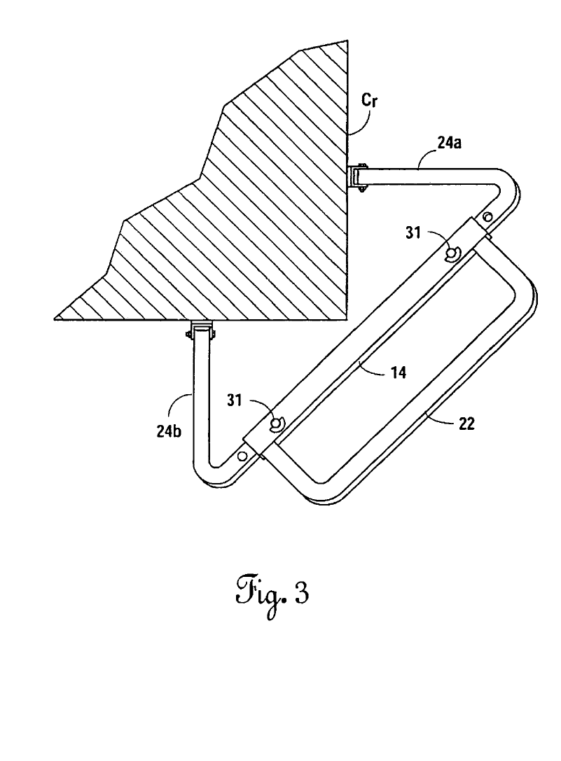

FIGS. 1 through 10 illustrate some of the various configurations of Applicant's novel ladder stabilizing and standoff system 10. Ladder stabilizing and standoff system 10 includes a base 12, includes a leg receiving member 14 having removed ends 14A and 14B. Leg receiving member 14 is typically straight and may include a foam or resilient sleeve 48 such as seen in FIG. 2 covering part of the exterior surface.

Attached to the leg receiving member 14 as seen in FIGS. 1 and 2 is U-shaped member 16, which is comprised of spaced apart lateral members 18 and 20 connected by a cross member 22. Cross member 22 is also typically straight and aligned with, but spaced apart from, leg receiving member 14. Components of base 12 typically lay in the same flat plane.

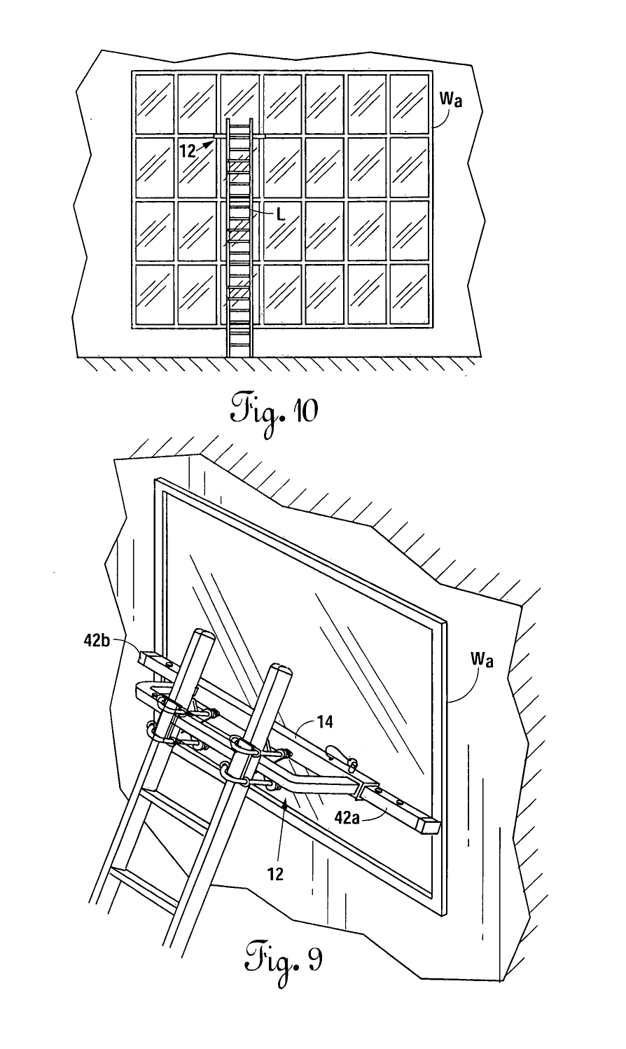

Leg receiving member 14 being straight is adapted to both lay generally flush against a straight wall Wa, for example as seen in FIG. 2, as well as providing a base for receiving a multiplicity of paired leg members as set forth below. U-shaped member 16 is adapted to receive a ladder, along the rungs and/or rails as seen in FIGS. 4, 9.

A multiplicity of different shaped paired leg members 24a/24b; 30a/30b; 36a/36b; and 42a/42b are illustrated in FIG. 1, each adapted with a straight near end to adjustably engage the removed ends 14A and 14B. Moreover, with reference to FIG. 1, it is seen that although the near ends of the various paired leg configurations are straight, so as to engage leg receiving member 14, the removed ends transcribe various angles with the near ends.

Further, it is seen that both removed ends 14A and 14B of leg receiving member 14 have at least one, and may have a multiplicity of fastener holes 27. Fastener holes 27 are designed to engage fastener holes 29 in the various straight near ends of the paired leg members so as to in one embodiment, adjustably set the distance that the removed ends of the paired leg members are spaced outward from base 12.

By having fastener holes 27 in base along with fastener holes 29 in straight near ends of the various paired members, one can telescopically adjust and set removed ends selectively from the base to accomplish a necessary span. Telescopic adjustment is helpful, for example, with a curtain wall, where you have structural metal and glass, the metal being spaced apart at various widths. With adjustment, you can set the removed ends of the straight paired leg members to contact the structural metal only.

Fasteners 31 such as bolts and nuts, ball lock pins or the like may be engaged with or without a lanyard 33 to base 12, and are intended to engage the aligned paired holes 27/29 to achieve the desired span for the selected leg members.

FIG. 1 illustrates four leg member pairs: 24a, 24b; 30a, 30b; 36a, 36b; and 42a, 42b. Each member of all the pairs has a straight near end with at least one or more fastener holes 29 therein which near end is dimensioned to be telescopically and slidably received within or without removed ends 14A and 14B of base 12 in a snug manner for engagement with one of a multiplicity of fastener holes 27 in base 12, which alignment will allow fasteners 31 to securely engage each leg of the pair to the base 12.

In one preferred embodiment, Applicant's system provides paired members 42a/42b and at least one of the remaining paired members (that is, paired members having curved removed ends). In another embodiment, Applicant's system may include any one of the various pairs.

Turning now to paired leg members 30a/30b, it is seen that these paired leg members may be provided with straight near ends 32a and 32b, but have removed ends 34a and 34b that transcribe approximately ninety-degree angles with the near ends. Paired leg members 30a/30b in this configuration may be suitable for spanning windows, for example, see FIG. 4.

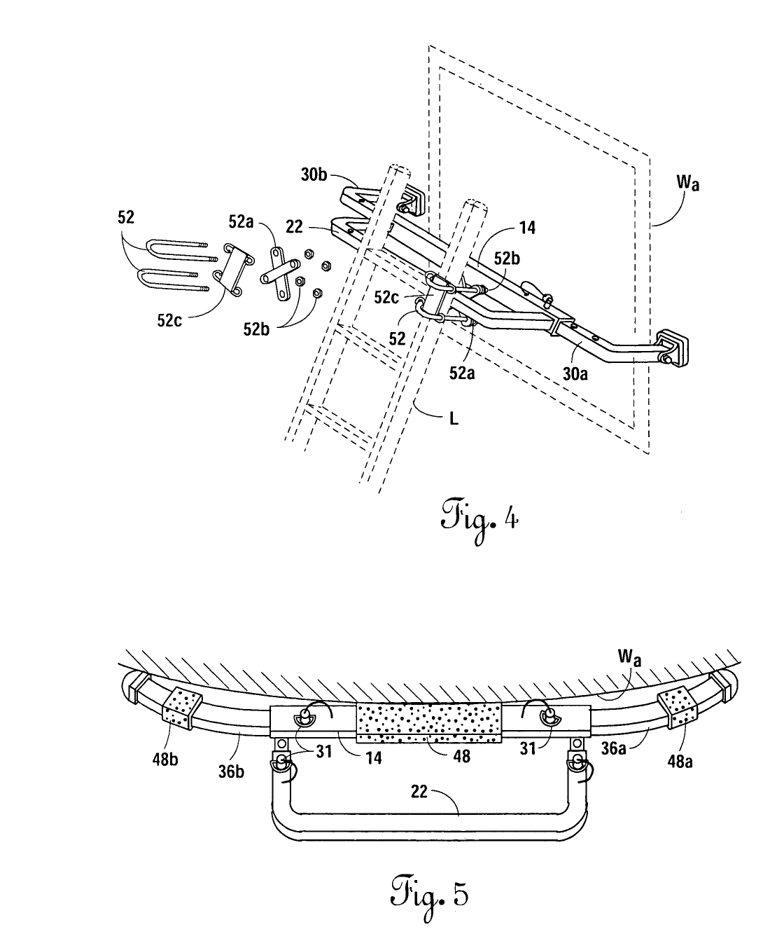

Paired leg members 36a and 36b are seen to have straight near ends 38a and 38b. Removed ends 40a and 40b typically transcribe an angle greater than ninety degrees, but less than one hundred eighty degrees, with the straight near end, for use on a wall with a curvature as seen in FIG. 5. Preferably, this angle is approximately one hundred-thirty five degrees.

Paired leg members 42a and 42b have straight near ends 44a and 44b. Removed ends 46a and 46b make an angle of one hundred eighty degrees with the near ends, that is to say paired leg members 42a and 42b are straight. These leg members can be used in a variety of scenarios, flat walls, curtain walls, or to bridge over an obstacle as seen in FIGS. 2, 9, and 10.

Turning now to FIG. 2, additional features of Applicant's preferred embodiment may be appreciated. A foam or resilient sleeve 48, such as that manufactured as Tubolit by Armacell LLC, may be provided for engagement with a portion of leg receiving member 14. Foam sleeve 48 may provide a more secure engagement with the wall and protection for delicate surfaces when paired leg members 36a, 36b and 42a, 42b are used as illustrated in FIGS. 2, and 5. Also included may be foam sections 48a and 48b near removed ends 40a, 40b and 46a, 46b of paired leg members 36a, 36b and 42a, 42b as seen in FIGS. 2 and 5.

FIG. 2 also illustrates adjustment structure 50 for adjustably setting a selected distance between leg receiving member 14 and cross member 22. In this embodiment, lateral members 18 and 20 are made of two pieces dimensioned for telescopically sliding one within the other. An arrangement of holes and fasteners are provided to adjustably set the distance in the same manner of the arrangement holes and fasteners that are used with the interchangeable leg members in FIG. 1. that is, the two parts telescope with alignment of holes, the holes align to adjustably set the distance between leg receiving member and cross member.

As seen in FIGS. 1, 4 and 9, U-bolt fastener clamps 52 with plates 52a and 52c (52a and 52c will sandwich rails together with cross member) and nuts 52b may be used to engage the ladder to cross member 22. FIG. 4 illustrates that the U-bolts will be used to engage the corners of the rung ladder side rail junctions and cross below and above cross member 22, so the U-bolts hold the flat portion of the cross member to the flat portion of the ladder side rails. (To prevent rotation of the system off the ladder)

FIG. 6 illustrates an embodiment of base 12 wherein the removed ends of the leg receiving member extend outward from the U-shaped member and may receive near ends of paired legs by telescoping within the legs.

The removed ends of the leg members of the pairs may have resilient cushion members 54, such as cushion members made of rubber, foam or any other material, dimensioned to slide on to, in to or attach to the removed ends of the leg members. Also, alternatively, adjustable feet may be provided, as seen in FIG. 7.

Applicant's system 10 may be comprised of any suitable material, for example, aluminum tubing, round, square or other suitable shape or cross-section. The aluminum may be aircraft quality seamless aluminum, such as 6061 T-6 aluminum, which may be anodized.

The spacing of the holes in paired leg members is designed to achieve a distance between the tips of the removed ends that can vary as needed.

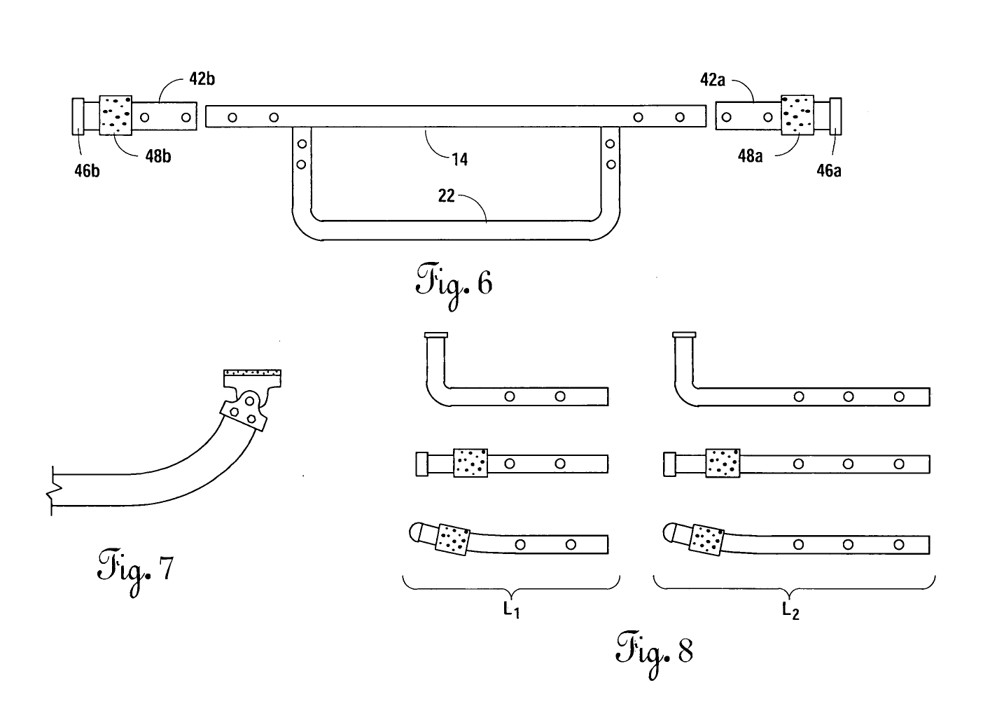

At least two sets of paired leg members 24a/24b, 30a/30b, 36a/36b, and 42a/42b may be provided, wherein they differ from one another in the length of straight near ends 26a/26b, 32a/32b, 38a/38b, and 44a/44b as seen in FIG. 8.

Applicant's system, in one embodiment, may include a pair of straight leg members and a pair of curved members. Applicant's system may also include more than one pair of leg members having curved removed ends. Any of the removed ends of Applicant's leg members may be provided with adjustable feet or cushions. Applicant's system may include, in one embodiment, pairs with curved ends, for example 30a/30b which may be reversed from the position as seen in FIG. 1 so that the curved removed ends are pointed out toward the ladder and the straight portions are used against a flat wall for stabilization. Applicant's system may include clamps or other suitable means for engaging the ladder to the cross member in a secure fashion. Applicant's ladder system may also include foam on one or more of the members that may engage a wall, or other surface, wherein the foam will be resilient and typically have a non-skid surface.

Although the invention has been described with reference to specific embodiments, this description is not meant to be construed in a limited sense. Various modifications of the disclosed embodiments, as well as alternative embodiments of the inventions, will become apparent to persons skilled in the art upon the reference to the description of the invention. It is, therefore, contemplated that the amended claims will cover such modifications that fall within the scope of the invention.

1. A ladder stabilizing and standoff system 10 comprising:
a base 12 having straight leg receiving member 14 and having a pair of removed ends 14a and 14b on the leg receiving member 14, the base 12 including a U-shaped member 16, U-shaped member 16 comprising two lateral members 18, 20, and a cross member 22, the removed ends of the straight leg receiving member including a multiplicity of fastener holes 27 therein;
a multiplicity of leg member pairs (24a/24b, 30a/30b, 36a/36b, 42a/42b), wherein each leg member of each leg member pair has a straight near end and a removed end, the straight near ends for telescopic or fixed engagement with removed ends of the leg receiving member, wherein the multiplicity of leg member pairs includes at least one pair having straight removed ends and at least one pair having curved removed ends, wherein the straight near ends of all leg members have at least one fastener hole therein, for alignment with one of the fastener holes in removed ends of the leg receiving member, and,
at least a pair of fasteners dimensioned for engaging the aligned fastener holes.

2. The ladder stabilizing and standoff system of claim 1, wherein:
each lateral member of the base is comprised of a pair of telescoping sections where one of the telescoping sections has at least one fastener hole and the other telescoping section has at least two fastener holes for adjustably setting the distance between the leg receiving member and the cross member of the base.

3. The ladder stabilizing and standoff system of claim 1, wherein:
the at least one leg member pair having curved removed ends includes leg members with the removed ends making a ninety-degree angle with the straight near ends.

4. The ladder stabilizing and standoff system of claim 1, wherein:
the at least one leg member pair having curved removed ends includes leg members with the removed ends making a substantially greater than ninety-degree angle with the straight near ends.

5. The ladder stabilizing and standoff system of claim 1, wherein:
the at least one leg member pair having curved removed ends includes leg members with the removed ends making an angle substantially less than a ninety-degree angle with the straight near ends.

6. The ladder stabilizing and standoff system of claim 1, wherein:
The multiplicity of leg member pairs include a leg member pair whose removed ends make an angle of about ninety degrees with the straight near end, a leg member pair whose removed ends make an angle of greater than ninety degrees with the straight near end, and a leg member pair whose removed ends make an angle of less than ninety degrees with the straight near end.

7. The ladder stabilizing and standoff system of claim 1, wherein the removed ends of the leg members of at least one leg member pair includes adjustable feet.

8. The ladder stabilizing and standoff system of claim 7, wherein the adjustable feet include a pin and pad, the pad pivotally mounted to the pin, the pin mounted perpendicular to a plane defined by the base.

9. The ladder stabilizing and standoff system of claim 1, further including at least a pair of clamps dimensioned to engage a ladder to the cross member of the base.

10. The ladder stabilizing and standoff system of claim 1, further including a foam member for engagement with at least a portion of the straight leg receiving member and other foam members for engagement with a portion of various paired leg members.

11. The ladder stabilizing and standoff system of claim 1, wherein the removed ends of the straight leg receiving member and the near ends of the leg members of the leg member pairs are dimensioned for telescopic engagement.

12. The ladder stabilizing and standoff system of claim 1, wherein the paired leg members 30a/30b, 36a/36b, and 42a/42b will come in two sets, wherein they differ from one another in the length of straight near ends.

13. A ladder stabilizing and standoff system comprising:
A base 12 having straight leg receiving member 14 and having a pair of removed ends 14a and 14b on the leg receiving member 14, the base 12 including a U-shaped member 16, U-shaped member 16 comprising two lateral members 18, 20 and a cross member 22, the removed ends of the straight leg receiving member including a multiplicity of fastener holes 27 therein;
a multiplicity of leg member pairs (24a/24b, 30a/30b, 36a/36b, 42a/42b), wherein each leg member of each leg member pair has a straight near end and a removed end, the straight near ends for lateral engagement with removed ends of the leg receiving member, wherein the multiplicity of leg member pairs includes at least one pair having straight removed ends and at least one pair having curved removed ends, wherein the straight near ends of all leg members have at least one fastener hole therein, for alignment with one of the fastener holes in removed ends of the leg receiving members;
at least a pair of fasteners dimensioned for engaging the aligned fastener holes;
wherein each lateral member of the base is comprised of a pair of telescoping sections where one of the telescoping sections has at least one fastener hole and the other telescoping section has at least two fastener holes for adjustably setting the distance between the leg receiving member and the cross member of the base;
wherein the multiplicity of leg member pairs include a leg member pair whose removed ends make an angle of about ninety degrees with the straight near end, a leg member pair whose removed ends make an angle of greater than ninety degrees with the straight near end, and a leg member pair whose removed ends make an angle of less than ninety degrees with the straight near end;
wherein the removed ends of at least some of the leg members of the leg member pairs include adjustable feet; and
at least a pair of clamps dimensioned to engage a ladder to the cross member of the base.

14. The ladder stabilizing and standoff system of claim 13, wherein the adjustable feet include a pin and pad, the pad pivotally mounted to the pin, the pin mounted perpendicular to a plane defined by the base.

15. The ladder stabilizing and standoff system of claim 14, wherein at least some of the removed ends of the leg members of the leg member pairs have padded cushions.

16. The ladder stabilizing and standoff system of claim 13, wherein the base and leg members are made of aluminum.
